(19) United States
(12) Patent Application Publication
(10) Pub. No.: US 2013/0089717 A1
(43) Pub. Date: Apr. 11, 2013

(54) METHOD FOR THE FABRICATION OF A STRUCTURE FROM AN ION GEL AND STRUCTURE FABRICATED THEREWITH

(71) Applicants: Ute Löffelmann, Glottertal (DE); Jan Gerrit Korvink, Karlsruhe (DE); Dario Mager, Freiburg (DE); Nan Wang, Waldkirch (DE)

(72) Inventors: Ute Löffelmann, Glottertal (DE); Jan Gerrit Korvink, Karlsruhe (DE); Dario Mager, Freiburg (DE); Nan Wang, Waldkirch (DE)

(73) Assignee: ALBERT-LUDWIGS-UNIVERSITÄT FREIBURG, Freiburg (DE)

(21) Appl. No.: 13/806,748

(22) PCT Filed: Jun. 23, 2011
(86) PCT No.: PCT/IB11/52751

§ 371 Date: Dec. 21, 2012

(30) Foreign Application Priority Data
Jun. 24, 2010 (DE) 102010024955.5
Sep. 29, 2010 (DE) 102010041690.8

(51) Int. Cl. B05D 7/24

(52) U.S. Cl. CPC B05D 7/24
USPC 428/195.1; 427/58; 252/500

(57) ABSTRACT

The invention relates to a method for the fabrication of structures from an ion gel. In particular, the invention relates to a method, wherein the structures are fabricated by way of ink jet printing technology, which comprises the following steps of
mixing at least one monomer with at least one ionic liquid to a printable liquid;
generating the structure by printing the printable liquid using ink jet printing technique; and
forming the polymer by means of polymerization, polyaddition or polycondensation of the structure;
   wherein common solvents are omitted.

Further, the invention relates to a structure comprising at least one layer of at least one ion gel, wherein the ion gel consists of a liquid which is initially printable by means of inkjet printing technique, the liquid comprising at least one ionic liquid as well as monomers which are solidified to a gel by means of polymerization because of subsequent energy exposition, and wherein the at least one ionic liquid is embedded physically and/or chemically into the ion gel, characterized in that the structure which can be formed directly onto a substrate consists of entirely homogenous ion gel layers, is at any time free of common solvents, of temperature-change induced distortion, of temperature-change induced shrinkage and/or swelling.

The invention relates to a method for the fabrication of a structure from an ion gel. In particular, the invention relates to a method wherein the structure is being fabricated by way of printing technique.

### State of the Art and Disadvantages

Transparent conductive materials have a broad range of application. They are being used in sensors, solar cells, displays, and other electronic components. Up to date, common materials for such applications are oxidic semiconductors (so-called TCOs, Transparent Conductive Oxides), which include e.g. ITO (Indium Tin Oxide), but also ICPs (Intrinsically Conductive Polymers), such as e.g. PEDOT (Poly(3,4-ethylenedioxythiophene)).

Regarding the increasing spread of flexible electronic components, characteristics such as mechanical flexibility and a most simple fabrication process are becoming more and more important. Therefore, polymeric electrolytes increasingly attract attention.

A relatively new and interesting class of such polymer electrolytes are so-called ion gels. They consist of a polymer matrix, which contains so-called ionic liquids. So, the GIT laboratory professional journal writes in its 01/2007 issue on pages 19 to 22, that ionic liquids would be “a new generation of solvents with a significant potential to substitute common organic solvents in numerous technical applications”, and defines: “Organic salt melts with a melting point below 100° C. are referred to as ionic liquids (IL). They have a very low vapor pressure, conduct electrical current, and have selective solvent characteristics. Ionic liquids consist of organic cations and organic or inorganic anions. Variation of the cationic base body, the alkyl rests of the cations, and variation of the anions result in a vast number of combination possibilities of the ionic liquids, which lead to broad ranges of characteristics regarding e.g. viscosity, density, hydrophobicity, and solvency. These characteristics can be adjusted according to the task at hand by modification of the functional groups of the cation and the anion and therefore can systematically be used for the optimization of processes.”

Thus, in ion gels, the attractive characteristics of ionic liquids such as electrical conductivity, chemical and thermal stability, hardly measurable vapor pressure, and transparency combine with the mechanical stability and flexibility of the polymers. For the fabrication of ion gels, the known fabrication methods for polymers from monomers are being used. Herein, the ionic liquid fulfils the function of a solvent for the monomers.

From the state of the art, e.g. casting or spin coating are known application techniques. However, a disadvantage of these solutions is the poor precision and the increased effort in cases when not large areas, but structured geometries shall be fabricated. The usage of the subtractive techniques implies a high consumption of source material. Furthermore, when using masks, templates, casting molds or the same, several process steps are necessary which are time- and therefore cost-intensive. Also, the flexibility is negatively influenced when using these techniques, since new masks etc. (see above) must be generated for every modification.

Further, methods are known from the art wherein polymers are printed by means of printing techniques (inkjet printing technique) onto substrates. Such a method is exemplary disclosed by document US 2008 0191200. Herein, in a first step, a block-copolymer is formed by way of polymerization. Subsequently, mixing with the ionic liquid takes place. Thereupon, the ion gel is formed. The viscosity of the ion gel is reduced by heating, such that it becomes processible. After the processing (fabrication of structures), the gel must cool down again. Then, the process is finished, the structure is fabricated.

However, because of the early polymerization and formation of the ion gel prior to the printing process, the viscosity of the liquid to be printed is increased, thus making the processability by means of ink jet printing technique more difficult. The heating step is time- and energy intensive; furthermore, the viscosity reduction which can be achieved by heating is limited. A particularly low viscosity which cannot be achieved in this manner is desirable for printing particularly fine structures, and thus for prevention of clogging of the printing nozzle. Other problems caused by heating the polymer material can be thermal damages at the material itself, but also at the cooled down structure (shrinkage, distortion).

A method which is proposed in document US 2009 0042346 applies an electrolytic precursor by means of printing onto a gelling agent. Thus, the fabrication of the ion gel occurs still during the printing. In this case, first of all, it is disadvantageous that a substrate must be present which is wetted on the entire surface with the gelling agent, which then—in the case of non-full area structures—only partially interacts with the precursor. Thus, an excess of gelling agent must be used. Furthermore, the method is only suitable for thin layers, since for high aspect ratios, no contact is established between the precursor and the gelling agent, and thus, no ion gel can be formed in depth by way of interaction; no homogeneous layer in the proper sense is present, the risk of a concentration gradient of the ionic liquid perpendicular to the printing direction is high. Furthermore, the disadvantage exists of the poorer local definition between imprinted and non-imprinted regions because of the deliquesce of the precursor on the gelling agent. The minimal structure width is therefore significantly limited to the lower end. Also, the imprinting/coating of the substrate itself with other materials (e.g. conducting paths) is impossible, since the substrate is fully coated with the gelling agent, that, in this case, would firstly have to be removed again. Likewise, the fabrication of several layers stacked above each other is impossible, unless new layers of gelling agent are being applied onto already imprinted regions, what in practice could be difficult. Another important aspect is the time that passes during the “mixing” of gelling agent and precursor. Since this “mixing” cannot actively be accelerated, the duration lies in unfavorable cases (thick layers) in the range of hours. Also, subsequent swelling or absorption in the case of an according substrate material (e.g. paper) can result in a change of the firstly precisely applied geometry. Since the direct printing onto a substrate is impossible, no self supported structures can be generated on the same.

### OBJECT OF THE INVENTION AND SOLUTION

The object of the invention is therefore providing a method which allows a fabrication of structures from ion gel, avoiding the disadvantages of the art. In particular, the viscosity of the printable liquid shall be as low as possible until the end of the printing process in order to achieve good printing results. Furthermore, if possible, an addition of additives which decrease viscosity shall be omitted. The time for forming the polymer shall be as short as possible, and the method shall allow the stacking of several, even different, ion gels. A structure which is fabricated by means of the method according to the invention shall neither have thermal damages, nor geometrical distortions because of distortion, shrinkage, or swelling.

A further object of the invention is the provision of a structure which has advantageously been fabricated with the method according to the invention. Further, the invention shall allow the realization of already known structures in a more cost-effective manner, and provide structures which have improved characteristics over the state of the art.

The object is solved by the method of the main claim as well as a structure according to claim 14. Further advantageous embodiments can be found in the description as well as in the figures.

### DESCRIPTION

Subsequently, at first, the method according to the invention is described in detail. Herein, particularly preferred compositions of the printable liquid are also being discussed, since they play a key role in the method.

The method according to the invention comprises at least the following steps:
mixing at least one monomer with an ionic liquid to a printable liquid;
generating the structure by printing the printable liquid using ink jet printing technique and/or casting; and
forming the polymer by means of polymerization, polyaddition or polycondensation of the structure;

Herein, it is essential that the printable liquid is free of solvents and contains only ionic liquids as solving medium. It is therefore clear, that the term “solving medium” refers to common, in particular organic, solvent mediums such as e.g. acetone, diacetone-alcohol, ethanol, or ethylene glycol. On the contrary, the term does not relate to ionic liquids, since these are a integral part according to the invention.

Thus, according to the invention, firstly, the fabrication of the mixture takes place which subsequently is referred to as printable liquid. Essentially for the printing process is a sufficiently low viscosity. By way of the usage according to the invention of monomers instead of polymers, the initial viscosity is kept low. This is important for the subsequent printing step.

Subsequently, the structure is fabricated by way of ink jet printing technique, preferably on a substrate. The term “inkjet printing technique” must be understood herein as a generic term for different technologies which will described in detail later on. By way of using the ink jet printing technology, its advantages can be used for the fabrication of ion gel structures: the advantage of the ink jet printing technique is on one hand the precise positioning and the fabrication of fine structures. On the other, this technique is a so-called “direct writes technology”. This means, that additional process steps such as a fabrication of masks can be omitted. A pattern (design) which is generated at the PC can immediately be printed, and it can be altered with very low efforts as often as desired. Furthermore, the ink consumption and waste is very low, which is economically and ecologically advantageous.

Finally, the reaction of the polymerizable components of the printable liquid takes place. Possibly, the structure to be fabricated does not exclusively contain polymerizable components, but also non polymerizable components such as e.g. metal particles. As far as such non polymerizable components are present, these are naturally not reactively integrated into the polymer, but embedded into the forming matrix. Therefore, according to a preferred embodiment, the polymerization of the structure relates only to a polymer formation of the polymerizable components of the structure. Insofar, not necessarily a polymerization of the (complete) structure, but, more precisely, a “polymer formation in the structure” takes place in the last step mentioned above.

Often, the term of the “polymerization” is used as a generic term in the scientific community for the mechanisms of polymerization, polymer addition, and polymer condensation, which must, in a strict sense, be differentiated from each other. Therefore, subsequently, the term “polymer formation” is being used for reasons of clarity, although the term “polymerization” is, to a large extent, exchangeable with the “polymer addition” and the “polymer condensation”. However, it is solely essential that the monomers which are present in the printed liquid build polymers in a certain way, wherein the respective mechanism (see above) is of minor importance and depends on the monomer selected by the expert.

According to the invention, a homogeneous, printable liquid is generated by combining the monomer with the ionic liquid and optionally an initiator which is typically necessary for the initiation of the reaction, as well as with optional additives such as auxiliary materials, stabilizers, conductivity increasing materials, accelerators and/or hardeners etc. This liquid can, depending on the respectively selected components, be present as a mixture in the form of a solution, an emulsion, or a dispersion. However, it must be noted that this liquid is not yet an ion gel. The same is only formed after the fabrication of the structures by means of printing technique or casting (e.g. embossing), wherein combinations of these or other techniques, being suitable in the context of a post processing (e.g. machining/cutting, using lasers), are possible. Since the polymerization takes place only at the end of the process, the viscosity is continuously being kept low, so that a simple and stable printing is possible. Essentially is a homogeneous mixture of the components. This allows for a stable printing process without clogging of the nozzles.

By means of the method according to the invention, a permanent structure is achieved which is fixed to the typically present substrate. By selection of the respective ionic liquids and monomers, ion gel structures with e.g. good electrical conductivity, transparency and flexibility can be generated.

Preferably, the application of the method according to the invention serves for the fabrication of structures from ion gel for the usage in micro technical components, and particularly preferred in such micro technical components with specific electrical and/or electromechanical characteristics. In this context, reference is made to the examples being described later on.

As mentioned before, different mechanisms are available for the formation of polymers. So, the same can take place by means of polymerization, polyaddition or polycondensation of the. It is preferred herein that the polymer formation takes place as free radical, cationic and/or anionic polymerization, and it takes place particularly preferred as free radical polymerization.

As mentioned above, the deposition of the printable liquid takes place by means of ink jet printing technique. This technique can be divided into “drop-on-demand” technique and “continuous flow” technique.

According to a preferred embodiment, drop-on-demand technique using piezo technology (“piezo jet printing”) is used as the ink jet printing technique. Piezo printers use the characteristic of piezo crystals to deform when subjected to an electrical voltage in order to press printing ink through the fine nozzle. Furthermore, a drop is generated in this technology only when the same is actually needed.

Another, less preferred embodiment uses the so-called “bubble-jet” technology, wherein the energy which is necessary for the acceleration of the drop is provided by abrupt heating and partial vaporizing, and therefore expanding, of the drop. It must be ensured that at no point in time a polymer formation of the printable liquid by way of the heating takes place. A further, also not preferred embodiment uses simple, so-called “continuous-flow” printers. These generate one or several continuous ink jets which are separated in individual droplets and which can be distracted by an electrical field. According to the needs, the ink jet is then targeted onto the substrate or into a recirculation.

Herein, it is clear that the term “ink jet printing technique” must not be narrowed to the actual printing using ink with the goal of imprinting on paper or comparable materials. The term means rather any technology which has emerged from the ones that were originally developed for the imprinting of paper or other materials with ink or ink-like liquids. These were firstly matrix printers, wherein a printing pattern is generated by the targeted firing of small ink droplets. The printing head being used therefore typically comprises a number of nozzles arranged next to each other in order to allow for a faster imprinting.

For an optimal printing result, the proper viscosity is essential. It mus lie in the so-called “printable region” of the respective printing technology. The viscosity depends, amongst others, form the printing temperature. It is therefore preferred that the viscosity of the printable liquid at a printing temperature of −20° C. to +100° C. is in the range from 0 mPas to 60 mPas, and preferably at a printing temperature of 0° C. to 70° C. is in the range below 30 mPas.

The printing head temperature can be increased for the reduction of the “ink viscosity” (viscosity of the printable liquid).

The printable liquid preferably consists according to the invention mostly of monomers of one or several types as well as of ionic liquids.

According to the invention it is envisaged that the printing liquid achieves the aforementioned values without the addition of viscosity reducing solvents or the like. Thus, no solvent must be removed after the printing process from the printed structures, for example by supplying heat and/or reduction of ambient pressure.

According to a particularly preferred embodiment, the aforementioned viscosity is adjusted by using monomers instead of polymers, and/or by application of heat in the region of the printing nozzle, while respectively omitting the solvent medium. The first mechanism has already been described above. The second mechanism is based on the fact that the viscosity of the printed liquid can be lowered by application of external heat heat and an according energy input. That must be ensured that no forming of polymer takes place due to excessive supply of energy, as long as the forming of the polymer is based on the supply of thermal energy, and not on e.g. an energy supply by means of ultraviolet light.

As already mentioned, it is envisaged according to the invention that the known addition of a common solvent for reasons of lowering viscosity is omitted at any time. Therefore, also, though subsequent evaporation of the solvent is necessary, the otherwise necessary process step is omitted; furthermore, the otherwise typical heating or evacuating for removing the solvent is omitted as well. Neither form solvent vapors during fabrication, nor can these develop in the following because of incomplete removal. Also, a partial dissolution of the substrate in the case of solvent sensitive substrates is excluded. Further, no defects in the polymers occur resulting from the solvent, and the frequently observed decelerated polymerization caused by the solvent is omitted.

According to a further preferred embodiment, the steps of printing and of the optional forming a polymer are carried out repeatedly. While by a single printing and polymerization, only planar structures can be fabricated, by printing of several layers stacked over each other, also three-dimensional structures can be achieved, and in particular, when the layer(s) are not printed full-surface, but laterally restricted over each other. Such methods are for example known from the so-called 3-D printing technique, which is being used in the field of rapid prototyping.

It is possible herein as well to print differently composed printable liquids on top of each other. As a result, also three-dimensional structures with different characteristics, e.g. different conductivities, can be fabricated in the different layers.

According to the needs, the formation of gel can take place by one single polymerization after finishing the printing processes, or the polymerization can take place after the printing of one respective layer.

According to the invention, in particular in that case when the forming of polymer takes place by free radical polarization, it is preferred that radiation, temperature increase, and/or radical formers are used for the reaction initiation of the polymer formation.

Preferably, the radiation is provided in the form of ultraviolet (UV) radiation, electron radiation, visible light, and/or infrared (IR) radiation.

Particularly preferred, UV radiation is used, such that accordingly, a UV induced polarization is present. Depending on the wavelength region, one speaks of UV-A-, UV-B- and UV-C radiation. Herein is preferred, that UV radiation from several of these UV regions is being used for polymerization. Experiments have shown that UV-C radiation results in an increased hardening of the surface regions. UV-C radiation is presently particularly preferred, since thin layers are common especially in ink jet printing. However, UV-A and UV-B radiation are particularly preferred for achieving a good through-hardening. Therefore, these radiations can be used particularly advantageous for thicker structures, or for several structures which must be hardened together in one step. It is obvious that the absorption bands of the initiators which typically must be added to the printable liquid must suit the respectively used radiation region. Exemplarily, Genocure MBF of Rahn AG, Zürich, can be mentioned which contains the active agent methylbenzoylformate, this ingredient having an absorption maximum lying in the UV region at 257 nm.

According to a particularly preferred embodiment, the different radiation regions of the UV radiation are combined with each other in such a manner, that a good surface hardening as well as a good through-hardening in the interior of the printed layer is achieved.

According to another preferred embodiment, in particular in the case when the polymer formation occurs by way of the free radical polymerization, the printing and/or the polymerization are carried out in protective gas atmosphere. In this way, the most complete polymerization is achieved. Preferably, nitrogen is used as protective gas. In this way it is ensured that an undesired inhibition of the reaction to the ion gel because of oxygen is avoided or at least reduced. The printing and the polymerization can therefore e.g. be carried out in a nitrogen containing glovebox.

In order to achieve a most complete polymerization, it is further preferred that the mixture or solution of monomer, ionic liquid, and optionally of initiator(s) is flushed prior to printing with a protective gas such as e.g. nitrogen.

It should further be added that in particular when using UV-C radiation, the printing in protective gas, particularly in nitrogen atmosphere, can be omitted.

According to another embodiment, after forming the polymer, the fabricated ion gel structure is coated with a stabilizing and/or protective layer, and/or is embedded into a stabilizing and/or protective environment or matrix, respectively. This means, that after completion of the structure or at least of one layer by polymer formation, one further process step takes place which serves for the protection of the structure. Here, in particular, protection against environmental influences such as light, humidity, mechanical impacts and/or chemical impairments can be mentioned. For this, polymers can preferably be used. These can for example be present in the form of polymer solutions, polymer dispersions, or in the form of reactive systems. For this, polydimethylsiloxane (PDMS) is preferably being used.

The fabrication of this layer or environment or matrix, respectively, can preferably take place by inkjet printing, casting, coating, and/or dipping.

According to another embodiment, the printable liquid contains conductivity-increasing materials The components which increase electrical conductivity can be nano materials from metals or carbon such as silver nano particles or carbon nanotubes (CNT), or organic additives as e.g. chemical compounds containing ether groups like tetrahydrofuran, containing lactone groups like γ-butyrolactone, containing amide- or lactam groups like N,N-dimethylformamide (DMF), sulfones and sulfoxides like dimethylsulfoxide (DMSO), sugar or derivates like sucrose, sugar alcohols like sorbitol, furan derivates like 2-furan-caboxylic acid, and/or di- or polyalcohols like ethylene glycol. It is thinkable that the conductivity depends on the dose of the energy which is introduced for the polymer formation, so that from the same printable liquid, polymers of differing conductivity can be fabricated.

For example, the printable liquid has prior to the polymer formation an electrical conductivity of at least 1 mS/cm, preferably of at least 6 mS/cm, and particularly preferred of at least 15 mS/cm.

After the polymer formation, the resulting structure has a conductivity of at least 0.1 mS/cm, preferably of at least 1 mS/cm, and particularly preferred of at least 10 mS/cm.

According to another embodiment, the printable liquid forms a transparent or opaque ion gel after the polymer formation. Typically, also the printable liquid, and particularly the used ionic liquid itself, are transparent; however it is also possible that the transparency is given after the polymerization.

Preferably, then, the printable liquid has a good transparency subsequent to the polymerization, which—for layer thickness of 170 μm and for a wavelength region of 400 to 700 nm—results in transmission values of at least 60%, preferably of at least 75%, and particularly preferred of at least 85%.

Subsequently, preferred characteristics of the printed liquid or its respective components are more precisely defined. Firstly, the monomers are discussed; subsequently, a description of the advantages ionic liquids is given.

Accordingly, the used monomers contain according to a preferred embodiment one to three ethylenically unsaturated groups such as in particular acrylate- and/or methacrylate groups. Even further vinyl monomers are preferably usable. By the usage of monomers together with several reactive groups, not only linear polymer chains, but also branched polymer structures and polymer networks can be fabricated, which has a significant positive influence on the mechanical characteristics on the ion gels and ion gel structures, since despite a lower monomer fraction, a gel with comparably well mechanical characteristics is achieved when using monomers having several reactive groups.

As already mentioned, the homogeneity and therefore the good miscibility of the components of the printable liquid are essential for the quality of the result. Experiments have shown that polar groups improve the miscibility of the monomers with the ionic liquids. Thus, according to further embodiments, the monomers used contain polar groups which can particularly be present in the form of ethylene oxide-, propylene oxide- and/or hydroxy-groups.

Preferably, monomers are being used which contain one up to twenty of these groups, and particularly preferred monomers with one up to five of these groups.

Examples for preferred monomers with ethylene oxide- or propylene oxide-groups are:
ethylene glycol di(meth)acrylate,
diethylene glycol di(meth)acrylate,
triethylene glycol di(meth)acrylate,
tetraethylene glycol di(meth)acrylate,
polyethylene glycol (200) di(meth)acrylate,
polyethylene glycol (400) di(meth)acrylate,
2-(2-EOEO)-ethyl (meth) acrylate,
dipropylene glycol di(meth)acrylate,
tripropylene glycol di(meth)acrylate.

Examples for preferred monomers with hydroxy-groups are:
hydroxyethyl acrylate
hydroxyethyl methacrylate
2-hydroxypropyl acrylate
2-hydroxypropyl methacrylate

According to another embodiment, monomer combinations can also be used for the generation of ion gel structures having specific characteristics. Accordingly, not only homo-, but also copolymers can be fabricated.

The monomer fraction in the printable liquid is typically from 5 to 90%, and preferably from 10 to 60%, and particularly preferred from 15 to 40%.

It is also desirable that monomers with a sufficiently low vapor pressure at 21° C. are being used since inkjet printing is not a closed system. It is therefore preferred that the monomers are of a type whose vapor pressure at 21° C. is below 6 mbar, preferably below 1 mbar, and particularly preferred below 0.1 mbar. In particular for thermally initiated polymer formation, a vaporization prior to the actual polymer formation is thus avoided.

With regard to advantageous ionic liquids it must be noted that besides the aforementioned monomers having unsaturated groups or polar groups, also ionic liquids with reactive groups can be integrated into the polymer structure via covalent bindings. By usage of such bindings it can be avoided that a separation takes place in the ion gel structures, what would result in escape of liquid from the gel structure.

Particularly preferred, ionic liquids with the following anions are being used:
dicyanamide anion (DCA-anion)
thiocyanate anion (SCN-anion)
bis(trifluoromethylsulfonyl)imide anion (BTA-anion)

Particularly preferred, as ionic liquids are being used:
1-ethyl-3-methyl imidazolium dicyanamide (EMIM DCA)
1-butyl-3-methyl-imidazolium dicyanamide (BMIM DCA)
1-butyl-1-methyl pyrrolidinium dicyanamide (BMPyrr DCA)
1-ethyl-3-methyl-imidazolium-thiocyanate (EMIM SCN)
1-ethyl-3-methyl-imidazolium
bis(trifluoromethylsulfonyl)imide (EMIM BTA)
1,3-diethyl-imidazolium bis(trifluoromethylsulfonyl)imide (DiEIM BTA)
1-butyl-3-methylimidazolium dicyanamide

According to another embodiment, the printable liquid has, subsequent to the polymer formation, a good mechanical flexibility. If e.g. a cylindrical sample with a diameter of 13 mm and a height of 2 mm would continuously be pressed between two flat metal plates with a speed of 0.15 mm/s, after traveling a distance of 0.4 mm, a maximum force of 25 N should be measured by the force transducer. Greater force values stand for harder/stiffer materials, smaller force values for softer/more flexible samples. The exemplarily mentioned values correspond approximately to a quarter of the value which would result by using a corresponding body made from PDMS (see above), and represents in this sense an upper limit to be strived for, since softer/more flexible materials are preferred. Thus, also flexible substrates can be imprinted without damaging the printed structure. The mechanical flexibility is adjusted by selection of specific monomer structures, and by selection of the monomer fraction in the printable liquid.

According to another embodiment, a flexible structure can be generated by firstly fabricating the same on an inflexible or flexible substrate which however does only provide little adhesive strength with the structure. After completion (hardening) of the structure, the same can easily be detached from the substrate. Therefore, the substrate can be accordingly bent for assistance if being flexible.

The invention relates also to a structure which has been fabricated by way of the method according to the invention. Accordingly, a structure according to the invention comprises at least one layer of at least one ion gel, or it comprises at least such a layer, wherein the ion gel consists of a liquid which is initially printable by means of inkjet printing technique, the liquid comprising at least one ionic liquid as well as monomers which are solidified to a gel by means of polymerization because of subsequent energy exposition, and wherein the at least one ionic liquid is embedded physically and/or chemically into the ion gel. Characteristic features of the invention are that the structure which can be formed directly onto a substrate consists of entirely homogenous ion gel layers, is at any time free of common solvents (see above), of temperature-change induced distortion, of temperature-change induced shrinkage and/or swelling. According to the definition, the ionic liquids which are present according to the invention do not count to the “common” solvents. The fact of being free of solvents is of particular advantage in medical applications for reasons of biocompatibility, because a certain rest of such solvents is always traceable in the final product, even if the solvent should theoretically be completely converted or evaporated.

Simply speaking, the structure according to the invention is characterized in that it comprises a liquid being free of solvents which is printable by means of ink jet printing directly onto a substrate, and which has been hardened to a gel by way of polymerization.

According to the invention, no intermediate layer being deposited onto the substrate such as e.g. a gelling agent is necessary, but the ion gel is generated directly on the rigid or also flexible substrate surface, from which it can be detached as well, if desired. Because of the viscosity of the printable liquid which is sufficiently low for printing, neither solvents nor heat supply are necessary, which is why the structure is free of solvents prior to and particularly also after the polymer formation, and does not show the typical damages or subsequent changes in geometry such as distortion, shrinkage and the like, caused by application of heat.

Thus, the structure can exclusively be built from the ion gel, or it can comprise further compounds as well, for example components for the mechanical stabilization, or conducting paths. For description of the configuration and the characteristics of the printable liquid, reference is made to the aforementioned explanations. However, the structure according to the invention still comprises the components of the printable liquid which are present as ionic liquid, but macroscopically, the structure is present in the form of a gel like solid body, whose stiffness is based on polymer formation of the structures which emerged from this printable liquid.

Particularly preferred characteristics of the structure according to the invention relate to the transparency and the electrical conductivity. Typically, these characteristics are already present in the printable liquid prior to the polymer formation. However, it is essential that not later than after the solidification of the liquid to a gel, the desired transparency, electrical conductivity, and/or mechanical flexibility is present as a result of the polymer formation.

According to a particularly preferred embodiment, the structure comprises several layers of identical or different printable liquids with identical or different chemical composition which are solidified to a gel by way of polymerization.

This means that the structure is present e.g. in the form of a three dimensional structure which is made of a homogenous material, or of layers from different materials. It is clear that besides the complete deposition of new onto already present layers, holes, undercuts, recesses etc. can be fabricated. Therein, a polymer formation takes place preferably after the deposition of each layer, as long as an undesired mixing or deliquesce of the liquid layers that are still present as liquids is likely to occur. Alternatively, several layers can be deposited one after the other, with a single subsequent step of polymer formation.

According to another preferred embodiment, the structure is applied onto a flexible substrate. It is clear that this is reasonable only if the structure itself provides according flexibility (see above).

The usage of a structure as described hereinbefore allows most different applications which can be based on the subsequently summarized effects:
Increase of conductivity by temperature increase and/or moisture absorption
Mechanical deformation and/or change of the refraction index by application of an electrical voltage
Change of the electric resistance by mechanical deformation, or vice versa.

From this result the following possible applications:
Optically transparent and/or mechanically flexible and elastic sensors for temperature, humidity, mechanical stress
Optically transparent and mechanically flexible actuators
tunable optical components

Selected applications are being subsequently discussed by way of application examples.

### Example 1

### Temperature Sensor

By means of the method according to the invention, microstructures are being printed. These are coupled to an evaluation unit which measures the conductivity. Upon temperature rise, the measured conductivity rises as well. After a calibration, the temperature can be calculated from the conductivity, and be postprocessed or displayed, if desired.

By the method according to the invention, very “fine” sensors can be fabricated (printed), e.g. lines with 100 μm width or less.

Furthermore, large areas can be covered with fine “sensor networks” (e.g. from crossing lines) by way of imprinting, so that spatially-resolved temperatures, and therefore spatial temperature differences, can also be measured. Thus, a targeted spatially-resolved temperature measurement and optionally temperature control is enabled. It is clear that a sensor network can be built from several, separately fabricated structures according to the invention, or that its fabrication can take place in one step.

Additionally, such a sensor or such a sensor network can be coated with a protective coating.

Complete applications are for example imprinted foils e.g. for greenhouses; imprinted wallpapers or windows; imprinted car headlining; imprinted clothing; prints directly onto the human body. Accordingly, the fields of applications of such a sensor are e.g. in architecture, in room planning, in functional and sportswear, in medicine, in construction of cold storage rooms, etc.

### Example 2

### Humidity Sensor

The fabrication is analogous to the temperature sensor. Upon increase of the humidity in the environment, conductivity rises. This enables the targeted spatially-resolved measurement and optionally control of the atmospheric humidity. It is clear that humidity sensors should have direct contact to the medium to be measured (e.g. the environmental atmosphere).

In addition to the applications mentioned regarding the temperature sensor, e.g. the detection of leakage (containers, tanks, flat roofs, . . . ) is an important field of application.

By coupling of temperature- and humidity sensors according to the invention, e.g. the targeted spatially-resolved measuring and control of the indoor climate is enabled in a cost-effective manner.

### Example 3

### Mechanical Sensor

By stretching (tension) or compression (pressure) a printed structure, the measured electrical resistance increases or decreases. Here as well, very thin sensor lines (e.g. 100 μm) can be fabricated without problems. Also, large areas can be coated with fine “sensor networks” (e.g. from crossing lines) by imprinting, so that a spatially resolved acquisition of the values is possible, and their spatial distribution can be measured.

For example, concrete applications relate to pressure sensors for measuring the mechanical pressure; vapor pressure sensors; touch sensitive displays (touch panels); applications in orthopedics and medicine, such as e.g. a gel sole that measures the load of a runner (walking analysis); sensors that are directly disposed on the body or which are integrated into a skin-tight dress for the analysis of motion processes; triggering an emergency call as a result of the missing signal of a carrying person (being immobile for a longer period), wherein the sensor(s) is/are applied in clothing, mattress, or to the body; the application as weighing machine sensor; measurement of growing or shrinking processes in biology; the measurement of deformations on materials; in the region of alarm systems and anti-theft devices a sensor which releases an alarm upon stepping on imprinted floors or carpets; a sensor which releases an alarm upon destroying imprinted glass panels or doors; the sealing of wrapping (alarm when opening the same).

### Example 4

### Actuator

By applying an electrical voltage, a motion is triggered. Such a sensor is known from literature (e.g. Saito, S., Katoh, Y., Kokubo, H., Watanabe, M. & Maruo, S.: “Development of a soft actuator using a photocurable ionic gel”, Journal of Micromechanics and Microengineering, 2009, 19(3)). The principle is based on a layer-wise sequence of a first electrode, a separation layer made from ion gel, and a second electrode. By means of applying a voltage to both electrodes, the actuator bends in direction of the positively charged electrode. By application of the method according to the invention, very small actuators can now be fabricated. Furthermore, their geometry is very variable because of the ink jet printing technique.

Possible applications are micro valves and micro pumps; the control and dosing of liquids in micro channels (lab-on-a-chip, micro fluidics); applications in the field of micro-robotics or “soft robotics”, artificial muscles, as well as applications of positioning in the micro region.

### Example 5

### Tunable Optical Component

If the principle which is mentioned in example 4 is used in the field of optical components such as lenses or mirrors, tunable components can be fabricated. These can vary their optical characteristics by means of one or several actuators, which, when being accordingly transparent, can be arranged at any place of the component—i.e. also within the optical path. This for example includes the focal length, but also the refraction index of e.g. a lens. The actuator structures can be arranged in full surface, ring shape, meander shape, grid- or radial shape onto, at, or inside the optical component.

Summarized, the invention allows, by the usage of technologies stemming from inkjet printing technology as an application method for the fabrication of ion gel structures, the fabrication of precise and comparably simply-to-fabricate ion gel structures, for example for the application in micro technical components, with certain electrical and/or electrome-chanical characteristics. The method according to the invention needs less steps than comparable methods. The structure which is fabricated by the method according to the invention provides layers wherein each is highly homogeneous. Several layers can be composed to three-dimensional structures. The geometrical accuracy is high, a risk of the subsequent change because of evaporation of solvents, swelling, distortion, or shrinkage is excluded. The time for forming the ion gel is comparably short, and by the possible usage of a multitude of different monomers, the gel composition and therefore the gel characteristics can be controlled very precisely.

### DESCRIPTION OF FIGURES

In FIG. 1, a process diagram of the method according to the invention is depicted. In a first step, the mixing and optionally dissolving of the monomer with the ionic liquid and an optional initiator (not depicted) takes place.

Subsequently, the structure is being fabricated by way of ink jet printing technique. Therein, it is possible that several sequences are carried out one of the other, and/or that further structuring processes such as e.g. embossing are being used (not depicted).

Eventually, the polymer formation of the monomers and the formation of the ion gel takes place. This can for example occur by temperature rise and/or by UV radiation.

It is clear that subsequent to this last step, a repetition of the second and once again of the last step can follow. This is of particular advantage when structures with high aspect ratios shall be fabricated, which can only be fabricated in multiple layers, wherein firstly, the “foundation”, and then additional “levels” are generated, and wherein therefore, a sufficiently stable ground must be fabricated beforehand.

FIG. 2 shows schematically a sensor network from several crossing lines of ion gel structures according to the invention. The network 1 has been fabricated by printing and can preferably comprise lines having a width of 100 μm or less. The electrodes 2 (only one with reference sign) serve for the connection of external control- and evaluation electronics 3 (only depicted once).

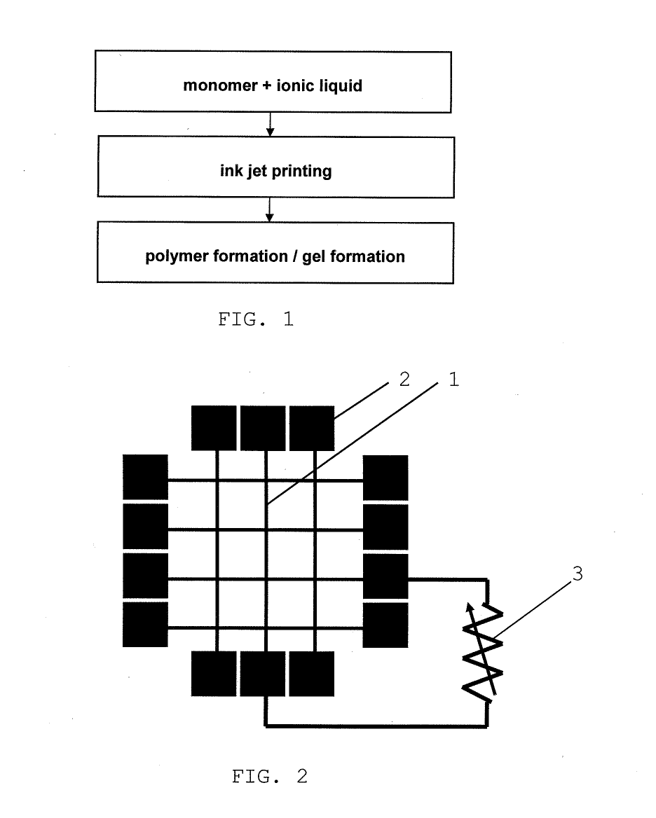

FIG. 3 implies how the multi layer printing of a structure according to the invention takes place. The printing head 4 firstly brings an individual drop 5 onto a substrate 6 (step a). A first layer is generated (step b) by way of the relative motion of substrate 6 and printing head 4 as well as ongoing dispensing. Now, further layers can be deposited (step c) by repeated replication of the previous track, optionally with correction of the distance between substrate 6 and printing head 4. Different characteristics can be realized in the individual layers or even parts of the same by variation of the content or the composition of the liquid. Recesses, holes, steps and the like (not depicted) can be fabricated by variation of the tracks of the individual “levels”. If necessary, subsequent to the disposition of single layers, a polymer formation can take place; in particular, when otherwise, an (undesired) coalescing of the layers is likely to take place.

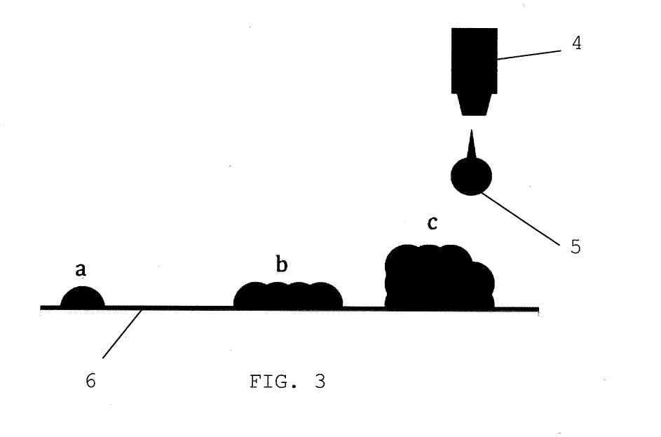

### LIST OF REFERENCES

1 network

2 electrode

3 electronics

4 printing head

5 drop

6 substrate

1. Method for the fabrication of structures from an ion gel, comprising the following steps:
mixing at least one monomer with at least one ionic liquid to a printable liquid;
generating the structure by printing the printable liquid using an ink jet printing technique; and
forming the polymer by means of polymerization, polyaddition or polycondensation of the structure;
wherein the printable liquid is free of solvents.

2. Method according to claim 1, wherein the step of forming the polymer takes place as free radical polymerization.

3. Method according to claim 1, wherein drop-on-demand technique using piezo technology is used as the ink jet printing technique.

4. Method according to claim 1, wherein the viscosity of the printable liquid at a printing temperature of −20° C. to +100° C. is in the range from 0 mPas to 60 mPas or at a printing temperature of 0° C. to 70° C. is in the range below 30 mPas.

5. Method according to claim 4, wherein the viscosity is adjusted by using monomers instead of polymers, and/or by application of heat in the region of the printing nozzle.

6. Method according to claim 1, wherein the steps of printing and of the optional forming a polymer are carried out repeatedly.

7. Method according to claim 2, wherein radiation, temperature increase, and/or radical formers are used for the reaction initiation of the polymer formation.

8. Method according to claim 2, wherein the printing and/or the polymerization are carried out in a protective gas atmosphere.

9. Method according to claim 1, wherein after forming the polymer, the fabricated ion gel structure is coated with a stabilizing and/or protective layer, and/or is embedded into a stabilizing and/or protective environment.

10. Method according to claim 1, wherein the printable liquid contains conductivity-increasing materials.

11. Method according to claim 1, wherein the printable liquid forms a transparent ion gel after the polymer formation.

12. Method according to claim 1, wherein the used monomers contain one to three ethylenic unsaturated groups, optionally acrylate and/or methacrylate groups.

13. Method according to claim 1, wherein the monomers contain polar groups, optionally selected from the group consisting of ethylene oxide, propylene oxide, and hydroxy groups.

14. Structure, comprising at least one layer of at least one ion gel, wherein the ion gel consists of a liquid which is initially printable by means of inkjet printing technique, the liquid comprising at least one ionic liquid as well as monomers which are solidified to a gel by means of, polymerization because of subsequent energy exposition, and wherein the at least one ionic liquid is embedded physically and/or chemically into the ion gel, characterized in that the structure which can be formed directly onto a substrate consists of entirely homogenous ion gel layers, is at any time free of common solvents, of temperature-change induced distortion, of temperature-change induced shrinkage and/or swelling.

15. Structure according to claim 14, wherein the printable liquid which is solidified to a gel by way of polymerization is transparent, electrically conducting, and/or mechanically flexible.

16. Structure according to claim 14, wherein the structure comprises several layers of identical or different printable liquids which are solidified to a gel by way of polymerization.

17. Structure according to claim 14, wherein the structure is built three-dimensionally.

18. Structure according to claims 14, wherein the structure is applied onto a flexible substrate.

19. Sensor, comprising at least one structure according to claims 14, wherein the sensor reacts to changes of humidity, temperature, pressure, and/or elongation.

20. Actuator, comprising at least one structure according to claims 14, wherein the actuator reacts to the change of the electric voltage with a mechanic deformation.

21. Lens, comprising at least one structure according to claims 14, wherein the same reacts to changes of the electric voltage with a change of its refraction index.

22. Object comprising a network of structures according to claim 14.
